(19) United States
(12) Patent Application Publication
(10) Pub. No.: US 2023/0398457 A1
(43) Pub. Date: Dec. 14, 2023

(54) EXTENSIBLE BLOCKCHAIN APPLICATION PLATFORM

(71) Applicant: ATMTA, Inc., Las Vegas, NV (US)

(72) Inventors: Jacob A. Floyd, Peyton, CO (US); Jonathan S. Sawler, Charlottetown (CA); Michael D. Tourigny, Ontario (CA)

(21) Appl. No.: 18/333,188

(22) Filed: Jun. 12, 2023

Related U.S. Application Data
(60) Provisional application No. 63/366,303, filed on Jun. 13, 2022.

(51) Int. Cl. A63F 13/69; A63F 13/70; H04L 9/00; H04L 9/32

(52) U.S. Cl. CPC A63F 13/69; A63F 13/70; H04L 9/50; H04L 9/3213

(57) ABSTRACT

Techniques relating to an extensible blockchain application are disclosed. The techniques include generating a game engine request for an electronic game based on user interaction with a graphical game engine for the electronic game. The techniques further include updating game state for the electronic game on a blockchain by transmitting the game engine request to at least one of a plurality of software programs maintained in the blockchain. The techniques further include modifying graphical presentation of the electronic game based on the updated game state on the blockchain.

### CROSS-REFERENCE TO RELATED APPLICATIONS

This application claims benefit of U.S. Provisional Patent Application Ser. No. 63/366,303 filed on Jun. 13, 2022. The aforementioned related patent application is herein incorporated by reference in its entirety.

### INTRODUCTION

Multi-user applications, like massively multiplayer online games (MMOs), typically rely on centralized control. A game developer or publisher, or another controlling entity, maintains a collection of servers to control and manage gameplay. Users login to the servers to use the application (e.g., the electronic game), and the controlling entity manages interaction with the application (e.g., gameplay) for connected users. But this centralized control has numerous disadvantages, including limiting scalability, creating centralized potential points of failure, and limiting the ability of third party extensions and improvements to the application.

### DESCRIPTION OF THE DRAWINGS

So that the manner in which the above recited aspects are attained and can be understood in detail, a more particular description of embodiments described herein, briefly summarized above, may be had by reference to the appended drawings.

It is to be noted, however, that the appended drawings illustrate typical embodiments and are therefore not to be considered limiting; other equally effective embodiments are contemplated.

FIG. 1 depicts a computing environment for an extensible blockchain application platform, according to one embodiment.

FIG. 2 depicts a block diagram for a computing device for an extensible blockchain application platform, according to one embodiment.

FIG. 3 is a flowchart illustrating updating game presentation from blockchain events for an extensible blockchain application platform, according to one embodiment.

FIG. 4 is a flowchart illustrating game engine and blockchain interaction for an extensible blockchain application platform, according to one embodiment.

FIG. 5 is a flowchart illustrating tracking movement for an extensible blockchain application platform, according to one embodiment.

FIG. 6 is a flowchart illustrating determining whether movement is permitted, according to one embodiment.

FIG. 7 is a flowchart illustrating determining whether cargo movement is permitted, according to one embodiment.

FIG. 8 is a flowchart illustrating determining whether container movement is permitted, according to one embodiment.

FIG. 9 is a flowchart further illustrating completing object movement, according to one embodiment.

To facilitate understanding, identical reference numerals have been used, where possible, to designate identical elements that are common to the drawings. It is contemplated that elements and features of one embodiment may be beneficially incorporated in other embodiments without further recitation.

### SUMMARY

Embodiments include a method. The method includes generating a game engine request for an electronic game based on user interaction with a graphical game engine for the electronic game. The method further includes updating game state for the electronic game on a blockchain by transmitting the game engine request to at least one of a plurality of software programs maintained in the blockchain. The method further includes modifying graphical presentation of the electronic game based on the updated game state on the blockchain.

Embodiments further include a system, including a processor and a memory having instructions stored thereon which, when executed on the processor, performs operations. The operations include generating a game engine request for an electronic game based on user interaction with a graphical game engine for the electronic game. The operations further include updating game state for the electronic game on a blockchain by transmitting the game engine request to at least one of a plurality of software programs maintained in the blockchain. The operations further include modifying graphical presentation of the electronic game based on the updated game state on the blockchain.

Embodiments further include a non-transitory computer-readable medium having instructions stored thereon which, when executed by a processor, performs operations. The operations include generating a game engine request for an electronic game based on user interaction with a graphical game engine for the electronic game. The operations further include updating game state for the electronic game on a blockchain by transmitting the game engine request to at least one of a plurality of software programs maintained in the blockchain. The operations further include modifying graphical presentation of the electronic game based on the updated game state on the blockchain.

### DETAILED DESCRIPTION

Aspects of the present disclosure provide apparatuses, methods, processing systems, and non-transitory computer-readable mediums for an extensible blockchain application platform. As discussed above, traditional MMOs (and other multi-user application) rely on centralized control. In an embodiment, this can be improved by instead using blockchain technology to allow decentralized control and management of an MMO.

In an embodiment, a blockchain can act as a decentralized, immutable database that is secured by its network. Typically, the larger the network the more secure it is. For example, because data stored on a blockchain is immutable and decentralized, the data can be used to represent a digital form of a tangible asset. Assets owned on a blockchain therefore typically cannot be replicated or destroyed. This makes non-fungible tokens (NFTs), and crypto-currencies common use cases for blockchain managed data.

As discussed further herein, blockchains can further be used to implement an electronic video game (e.g., a de-centralized MMO), in which gameplay interactions are recorded on a blockchain (e.g., in real-time, or near real-time). Non-fungible, or semi-fungible, blockchain units can be used to represent assets in the MMO (e.g., NFTs), and software code used to manage and control gameplay can be stored on the blockchain. Thus, an initial electronic game developer can create software code used to manage gameplay, and initial assets used for gameplay, and can deploy both the software code and tokens representing the assets in a blockchain. The developer can create a graphical presentation engine to run in a local computing environment for a user and display the gameplay environment, while the back-end game environment assets and controlling software code are maintained on the blockchain. This allows for decentralized access by users to play the electronic game, import assets into the gameplay environment (e.g., import NFTs representing gameplay items), and export assets from the gameplay environment into the real world (e.g., gameplay assets, currency, or other items holding value outside of the gameplay environment).

In an embodiment, this has numerous technical advantages. For example, as discussed above, existing MMOs require centralized control. A game developer, publisher, distributer, or another entity must maintain a central server or collection of computational resources to allow users to play the game and to control user assets. This significantly harms scalability of the MMO, because the centralized server must be expanded to allow for connections from additional users and to maintain game state data in centralized storage (e.g., in cloud storage or another suitable storage location). It also creates a centralized point of failure, where an error in the centralized control can block gameplay or erase gameplay assets, among other potential problems.

One or more techniques discussed herein significantly improve on this by maintaining game control software code, game assets, or both, on a decentralized blockchain. For example, these techniques significantly improve scalability. Because blockchains (e.g., the Solana™ blockchain or any other suitable blockchain) are decentralized, they allow for rapid and seamless expansion of computational and storage resources. This allows the MMO to rapidly scale up with user growth, without requiring intervention from a centralized authority. Further, storage in a decentralized blockchain is typically initiated, and paid for, by the entity requesting storage. Thus the MMO can be quickly expanded by recording additional assets or software code to the blockchain, with the entities adding the assets or software code responsible to initiating and paying for the additional storage (e.g., as opposed to a central authority).

As another example, maintaining game control software code, game assets, or both, on a decentralized blockchain, mitigates the central point of failure in prior solutions. Blockchains with large user bases are distributed across an extremely large number of compute devices. This significantly reduces the risk of a central failure blocking gameplay. Further, storing gameplay assets as tokens (e.g., NFTs) recorded in a blockchain ensures that the assets will not be erased or lost should a central server fail. Instead, the record of ownership of the tokens is distributed across the decentralized blockchain, such that users can be confident that assets will not be erased.

Deploying software code on a decentralized blockchain also provides for improved security while allowing for third party developers to extend the MMO and develop additional gameplay features. Traditional MMOs are controlled by a code base that is maintained by a central authority. To ensure security, third party developers typically cannot access the centralized code base and cannot easily extend the code base to add additional features. Deploying software code on a decentralized blockchain improves on this by allowing an initial developer to maintain some limited control of modification of the game control software code (e.g., by maintaining keys off-chain and managing authorities), while allowing third party developers to access the code, extend the code, and deploy the extended code in the blockchain for users to access. The blockchain can be used to ensure that the initial code is secure from modification or exploitation, while allowing third party developers to both access and extend the code, and allowing users to easily access the newly developed features through the blockchain.

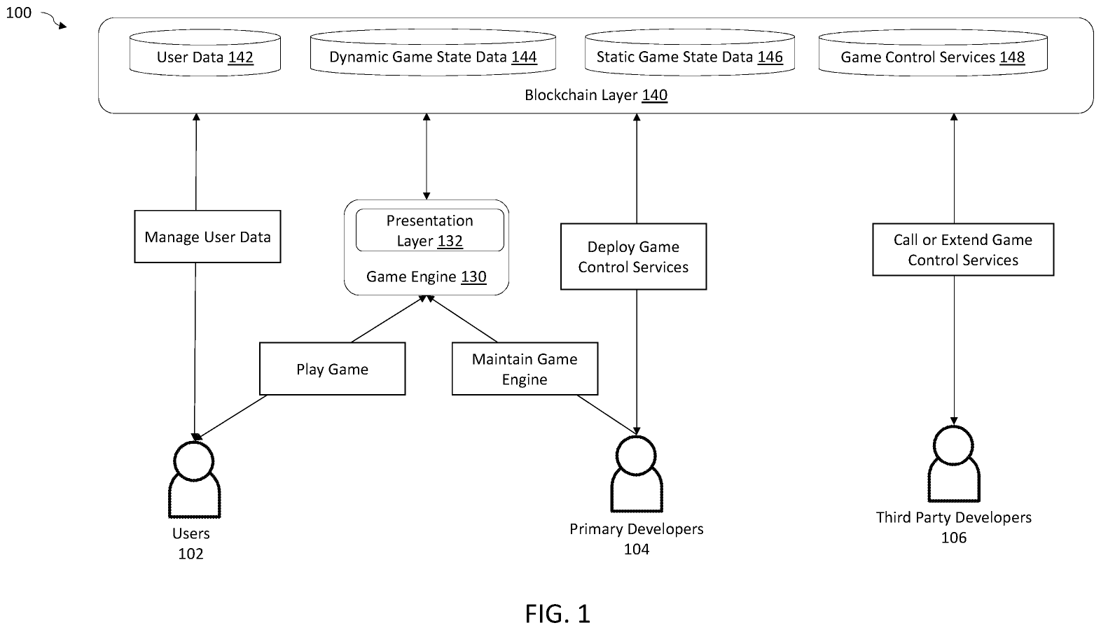

FIG. 1 depicts a computing environment 100 for an extensible blockchain application platform, according to one embodiment. In an embodiment, one or more users 102 play a game (e.g., a MMO) using a game engine 130. For example, the game engine 130 can be a graphical game engine and present graphics to one or more of the users 102 (e.g., using a presentation layer 132) based on game information stored in a blockchain layer 140, allowing the user(s) to play the game. While FIG. 1 focuses on an electronic game as one example of an extensible blockchain application, it is merely an example. One or more of the techniques disclosed herein can be applied to any suitable multi-user application.

As illustrated, both game data and game control software code are stored in the blockchain layer 140. In an embodiment, game control services 148 can be software code stored in the blockchain layer 140 and used to control gameplay, while dynamic game state data 144 and static game state data 146 can be game state data stored in the blockchain layer 140 and used to record game assets and state. For example, the blockchain layer 140 can use the Solana™ blockchain. The game control services 148 can be programs deployed on the Solana™ blockchain and the dynamic game state data 144 and static game state data 146 can be data stored on the Solana™ blockchain. This is merely an example, and the blockchain layer 140 can use any suitable blockchain (e.g., the Ethereum® blockchain or any other suitable blockchain) or any combination of blockchains (e.g., different blockchains can be used to implement different aspects of the blockchain layer 140).

In an embodiment, the game control services 148 can be deployed by one or more primary developers 104 onto the blockchain layer 140 (e.g., onto the Solana™ blockchain) and can be accessed by a variety of clients, including the users 102, the game engine 130, and third party developers 106. For example, the game engine 130 can interact with the game control services 148 in the blockchain layer 140 to control presentation of game graphics (e.g., using the presentation layer 132). In this example, the presentation layer 132 can implement a suitable game presentation engine (e.g., the Unreal Engine®). The presentation layer 132 can be deployed in a user's local computing environment (e.g., on a computing device local to the user 102), and can interact with back-end functionality maintained in the blockchain layer 140 (e.g., using the game control services 148).

The game engine 130 can transmit requests to the game control services 148 (e.g., using the JavaScript Object Notation Remote Procedure Call (JSON-RPC) protocol, or any other suitable RPC protocol or other suitable technique) for information about the game state. The game control services 148 can access game state data stored in the blockchain layer 140 (e.g., dynamic game state data 144 and static game state data 146) and can respond to the game engine 130 with the game state data. The presentation layer 132 (e.g., the Unreal Engine® implementation) can then render a suitable graphical interface for the game, using the game state data. The presentation layer 132 can be any suitable graphical implementation, including a two-dimensional graphical engine, a three-dimensional graphical engine, an augmented reality graphic engine, a virtual reality graphical engine, or any other suitable graphical engine.

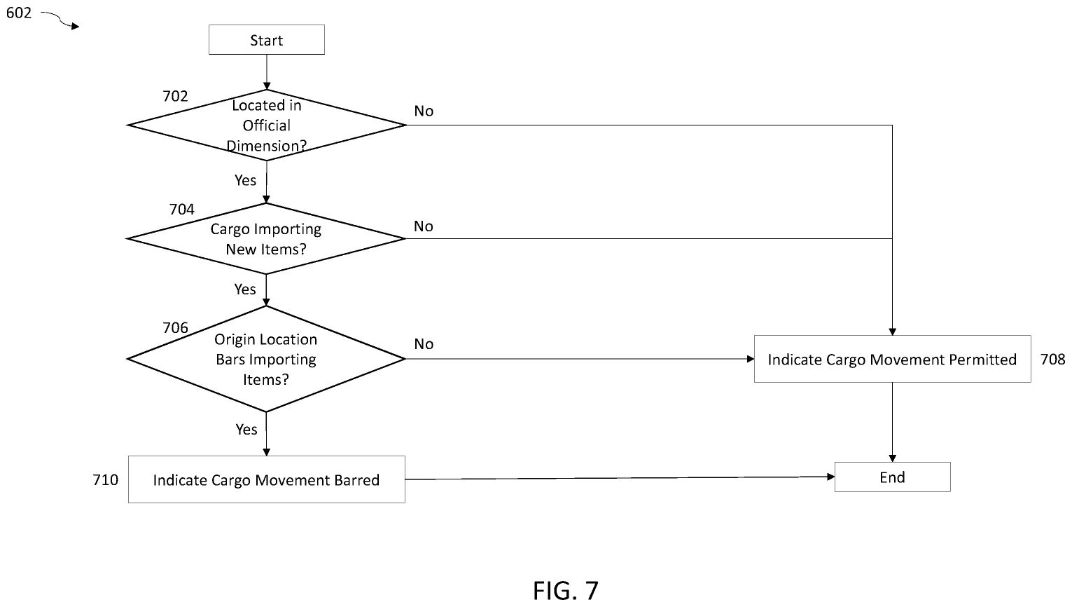

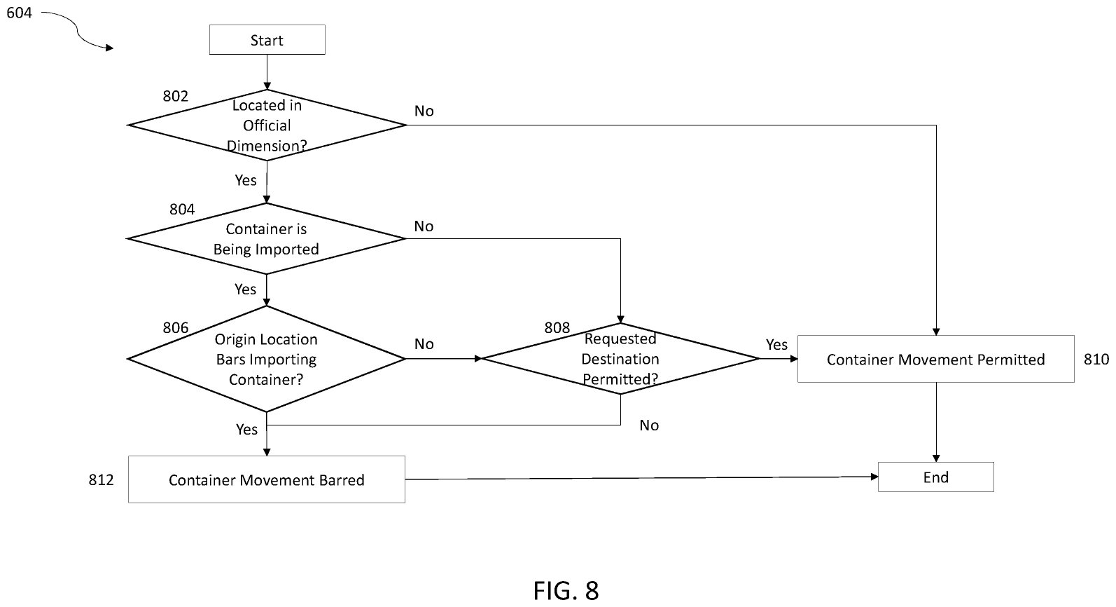

As another example, one or more users 102 can access the blockchain layer 140 to store and retrieve user data 142. For example, the blockchain layer 140 can include tokens that have value outside of the game experience. This can include NFTs (e.g., corresponding to game items, images or videos related to the game, or any other suitable items) or semi-fungible tokens. In an embodiment, a user 102 can retrieve these tokens from the user data 142, transfer the tokens to another entity, or otherwise manage the tokens. For example, as discussed further below with regard to FIGS. 7-8, items in the gameplay environment (e.g., spaceships, cargo items, and any other suitable items) can be represented using tokens (e.g., NFTs or semi-fungible tokens). These tokens can be stored in the blockchain layer 140 as user data 142, and can be withdrawn from the gameplay environment, transferred between users, and imported into the gameplay environment.

As another example, the blockchain layer 140 can include currency that has value both inside the game experience and outside the game experience. In an embodiment, the users 102 can transfer ownership of this currency to a location outside the game experience (e.g., a wallet) and can otherwise manage the currency in any other suitable manner. For example, the gameplay environment can include one or more types of currency, accessible to the user. This can include currency for use in-game (e.g., to purchase items in-game and use in-game), and currency with value outside of the gameplay environment. In an embodiment, the user data 142 can include currency, and the user 102 can withdraw currency from the gameplay environment (e.g., to use outside of the gameplay environment), transfer currency to others within or outside of the gameplay environment, add currency to the gameplay environment, or manage the user data 142 in any other suitable manner. The transactions related to the currency are recorded in the blockchain layer 140.

In an embodiment, one or more primary developers 104 maintain the game engine 130 and deploy game control services 148. That is, as described above, the third party developers 106 can extend game control services 148 (e.g., to add additional features, modify features, remove features, or take any other suitable action). In this embodiment only the primary developers 104, however, can deploy the game control services 148 and maintain the game engine 130. This allows a minimal amount of centralized control to ensure security, fairness, and other game characteristics, while allowing for highly extensible and scalable gameplay (e.g., using the blockchain layer 140).

For example, the primary developers 104 can maintain suitable authentication keys, off-chain, and can use the keys to manage authorities and control changes to the game control services 148. But the primary developers 104 can allow third party developers 106 to call the game control services 148, without modifying the game control services 148. Further, the software code used to implement the game control services 148 is recorded in the blockchain layer 140, allowing the third party developers 106 to access and extend the game control services. Third party developers 106 can create their own software code extending the game control services 148, and can record their extended programs in the blockchain. Thus, third party developers 106 can create their own extended implementations of gameplay functions (e.g., adding features, modifying features, or any other suitable extended implementation) based on the transparent and distributed access to the game control services 148 through the blockchain layer 140, without risk that the game control services 148 will themselves be modified or broken. Further, third party developers 106 can deploy their extended code (e.g., with new features) on the blockchain layer 140 to allow for ready access by the users 102.

In an embodiment, the various elements of the computing environment (e.g., any, or all, of the users 102, primary developers 104, third party developers 106, game engine 130, and blockchain layer 140) interact using a suitable communication network and suitable computing devices (e.g., server computers, cloud computing nodes, laptop computers, desktop computers, smartphones, tablet computers, smart watches and wearable devices, head mounted displays, embedded devices, and any other suitable computing devices). For example, the users 102 can interact with the game engine 130 and the blockchain layer 140 using a local area network (LAN), a wide area network (WAN), the Internet, or any other suitable communication network. Further, the various elements of the computing environment (e.g., any, or all, of the users 102, primary developers 104, third party developers 106, game engine 130, and blockchain layer 140) can be connected to the communication network using any suitable network connection, including a wired connection (e.g., an Ethernet or fiber optic connection), a wireless connection (e.g., a WiFi connection), a cellular connection, or any other suitable network connection.

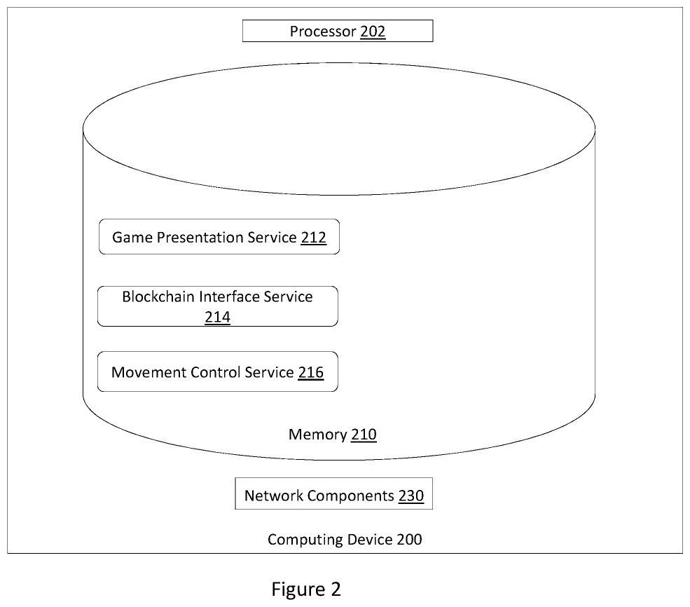

FIG. 2 depicts a block diagram for a computing device 200 for an extensible blockchain application platform, according to one embodiment. In an embodiment, the computing device 200 corresponds with one or more aspects of the game engine 130 illustrated in FIG. 1. The computing device 200 includes a processor 202, a memory 210, and network components 230. The memory 210 may take the form of any non-transitory computer-readable medium. The processor 202 generally retrieves and executes programming instructions stored in the memory 210. The processor 202 is representative of a single central processing unit (CPU), multiple CPUs, a single CPU having multiple processing cores, graphics processing units (GPUs) having multiple execution paths, and the like.

The network components 230 include the components necessary for the computing device 200 to interface with a suitable communication network (e.g., a communication network interconnecting various components of the computing environment 100 illustrated in FIG. 1, or interconnecting the computing environment 100 with other computing systems). For example, the network components 230 can include wired, WiFi, or cellular network interface components and associated software. Although the memory 210 is shown as a single entity, the memory 210 may include one or more memory devices having blocks of memory associated with physical addresses, such as random access memory (RAM), read only memory (ROM), flash memory, or other types of volatile and/or non-volatile memory.

The memory 210 generally includes program code for performing various functions related to use of the computing device 200. The program code is generally described as various functional “applications” or “modules” within the memory 210, although alternate implementations may have different functions and/or combinations of functions.

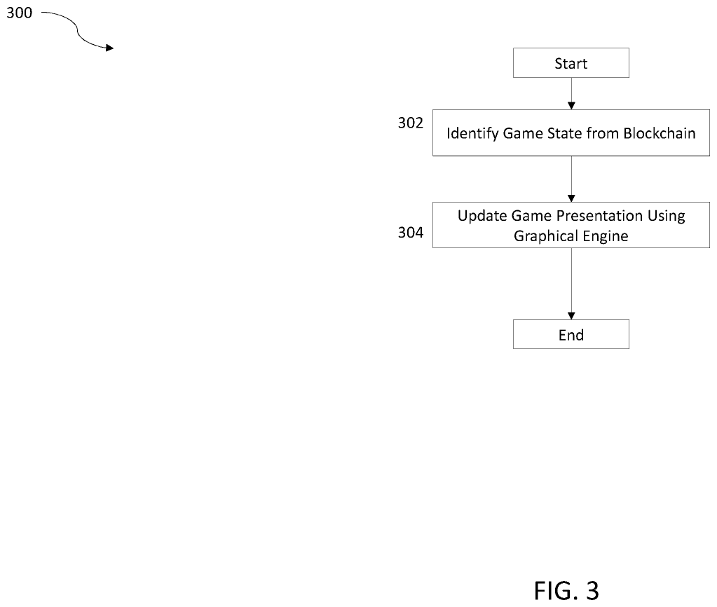

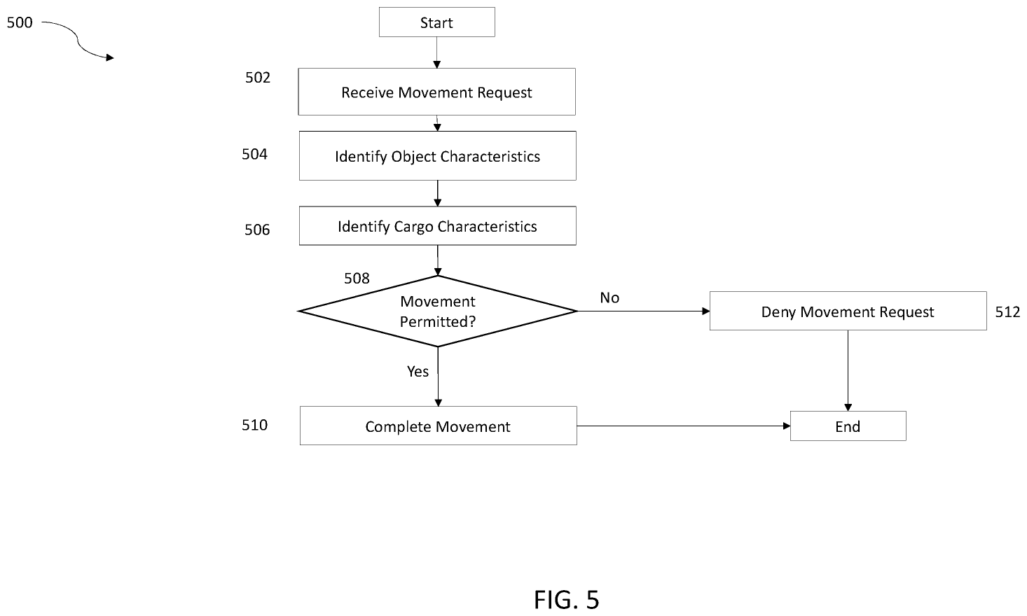

Within the memory 210, game presentation service 212 facilitates generating graphical presentation of a game (e.g., using an Unreal Engine® as discussed above in relation to the presentation layer 132 illustrated in FIG. 1). The game presentation service 212 can use any suitable graphical implementation, including a two-dimensional graphical engine, a three-dimensional graphical engine, an augmented reality graphic engine, a virtual reality graphical engine, or any other suitable graphical engine. This is discussed further, below, with regard to FIG. 3. The blockchain interface service 214 facilitates interaction between the computing device 200 and one or more blockchains (e.g., the blockchain layer 140 illustrated in FIG. 1). This is discussed further, below, with regard to FIGS. 3-5. The movement control service 216 facilitates control of movement of objects in the game. This is discussed further, below, with regard to FIGS. 5-8.

While the computing device 200 is illustrated as a single entity, in an embodiment, the various components can be implemented using any suitable combination of physical compute systems, cloud compute nodes and storage locations, or any other suitable implementation. For example, the computing device 200 could be implemented to operate on a user's local computing device. As another example, the computing device 200 could be implemented using a server or cluster of servers, or using a combination of compute nodes and storage locations in a suitable cloud environment. For example, one or more of the components of the computing device 200 can be implemented using a public cloud, a private cloud, a hybrid cloud, or any other suitable implementation.

Although FIG. 2 depicts the services 212, 214, and 216 as being mutually co-located in memory 210, that representation is also merely provided as an illustration for clarity. More generally, the computing device 200 may include one or more computing platforms, such as computer servers for example, which may be co-located, or may form an interactively linked but distributed system, such as a cloud-based system. As a result, processor 202 and memory 210 may correspond to distributed processor and memory resources within the computing environment 100. Thus, it is to be understood that any, or all, of the services 212, 214, and 216 may be stored remotely from one another within the distributed memory resources of the computing environment 100.

### Presenting Game Graphics Using Blockchain Data

FIG. 3 is a flowchart 300 illustrating updating game presentation from blockchain events for an extensible blockchain application platform, according to one embodiment. In an embodiment, at block 302 a blockchain interface service (e.g., the blockchain interface service 214 illustrated in FIG. 2) identifies game state from a blockchain. For example, the blockchain interface service can interact with a blockchain (e.g., a blockchain layer 140 illustrated in FIG. 1) to identify changes to the blockchain and process responses to programs executed in the blockchain. These changes can include changes to game state data (e.g., either, or both, of dynamic game state data 144 and static game state data 146 illustrated in FIG. 1), responses from game control services (e.g., the game control service 148 illustrated in FIG. 1), or any other suitable changes.

In one embodiment, the blockchain interface service acts akin to a cryptocurrency wallet and connects to a blockchain to identify game state data maintained in the blockchain. For example, the blockchain interface service can query the blockchain to identify either, or both, of dynamic game state data 144 and static game state data 146 illustrated in FIG. 1 and maintained in a blockchain. Alternatively, or in addition, the blockchain interface service interacts with game control services, maintained on a blockchain, to identify game state data. For example, the game control services can transmit requests to software programs maintained on the blockchain (e.g., Solana™ programs, Ethereum® smart contracts, or any other suitable software programs) and can receive in response a description of game state data.

Using Solana™ as an example, the game control services can be programs maintained on the Solana™ blockchain. The blockchain interface service can transmit a transaction, with one or more instructions, to a Solana™ cluster (e.g., to a Solana™ node in the cluster). The Solana™ runtime can pass the instructions to one or more programs deployed on the Solana™ blockchain (e.g., game control services), and the blockchain interface can receive a result from execution of the programs (e.g., a JSON result). In this example, the blockchain interface service can transmit a request to a program to identify game state data stored on the blockchain, and can receive in response an indication of the current game state (e.g., either, or both, of dynamic game state data 144 and static game state data 146 illustrated in FIG. 1). This is merely an example, and any suitable blockchain and technique can be used.

At block 304, a game presentation service (e.g., the game presentation service 212 illustrated in FIG. 2) updates game presentation using a graphical engine. In an embodiment, the game state data identified at block 302 can reflect various aspects of the game, including data describing the player, data describing other players, data describing non-player characters, data describing interactive objects in the environment, data describing non-interactive objects in the environment, and any other suitable data. The game presentation service can use this data to render a graphical interface, reflecting the game, for the player.

For example, the game presentation service can use the Unreal® engine (e.g., the Unreal® engine 5) to render a three-dimensional graphical user interface of the game for the player. The Unreal® engine can use one or more visual scripting tools (e.g., Blueprints Visual Scripting) to control rendering of the graphical user interface. The visual scripting tools can be used to script gameplay, using the game state retrieved from the blockchain, and render the game graphics to allow the player to play the game. This is merely an example, and any suitable graphical engine can be used, including another three-dimensional graphical engine (e.g., other than the Unreal® engine), a two-dimensional graphical engine, an augmented reality graphic engine, a virtual reality graphical engine, or any other suitable graphical engine.

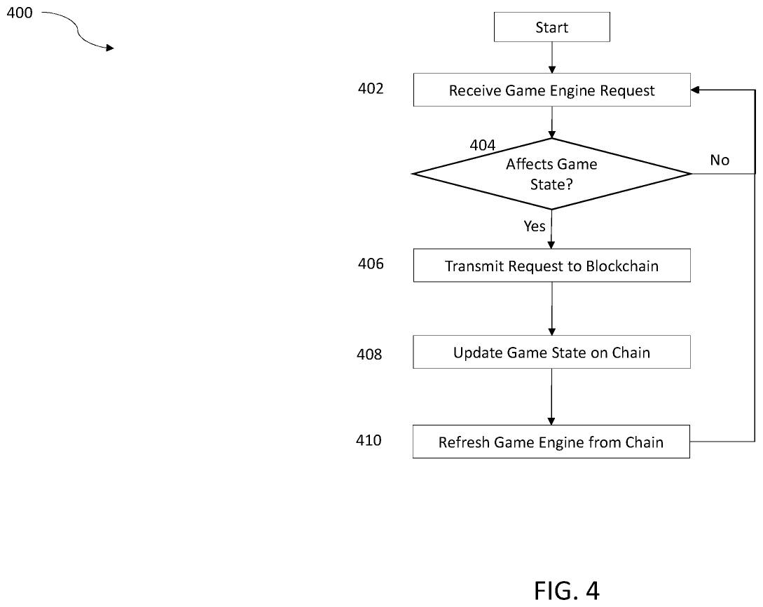

FIG. 4 is a flowchart 400 illustrating game engine and blockchain interaction for an extensible blockchain application platform, according to one embodiment. At block 402 a blockchain interface service (e.g., the blockchain interface service 214 illustrated in FIG. 2) receives a game engine request (e.g., a request from the game engine 130 illustrated in FIG. 1). In an embodiment, the game engine generates the request based on interaction from a user. For example, a user (e.g., the 102 illustrated in FIG. 1) can play a game using a suitable interface device (e.g., a mouse, keyboard, game controller, voice interface, wearable interface, ocular interface, or any other suitable interface device). The game engine can translate a user action into a game engine request. At block 402 the blockchain interface service receives this game engine request.

At block 404, the blockchain interface service determines whether the game engine request affects the game state. In an embodiment, the blockchain interface service interacts with the blockchain (e.g., transmitting a request to a blockchain program) for game engine requests that affect the game state, and does not interact with the blockchain for requests that do not affect the game state (e.g., requests that affect only the presentation of the game to the user). If the blockchain interface service determines that the game engine request does not affect the game state, the flow returns to block 402. If the blockchain interface service determines that the game engine request affects the game state, the flow proceeds to block 406.

Alternatively, the blockchain interface service does not include block 404 and all game engine requests are transmitted to the blockchain. In this example, the flow proceeds from block 402 to block 406, and all requests are transmitted to the blockchain. For example, the blockchain interface service can include limited, or no, game logic of its own and can rely on programs stored in the blockchain for game control.

At block 406, the blockchain interface service transmits a request to the blockchain. In an embodiment, the blockchain interface service can transmit a request to one or more game control services maintained on a blockchain (e.g., the game control services 148 illustrated in FIG. 1). For example, as discussed above, the game control services can be programs deployed on the Solana™ blockchain. The blockchain interface service can transmit a transaction, with one or more instructions, to the game control services deployed on the Solana™ blockchain.

In an embodiment, the game control services return a response. For example, the response can indicate whether the request is successful. In an embodiment, if the response indicates that the request is successful, the flow proceeds to block 408. If the response indicates that the request is not successful, the blockchain interface service takes appropriate action. For example, the blockchain interface service can retry the request. As another example, the blockchain interface service can generate an error, which can be presented to additional game logic (e.g., to allow the game logic to retry the game engine request) or to a user (e.g., to indicate the error).

At block 408, the game control services update game state on chain. For example, the game control services can be software programs maintained on the blockchain (e.g., Solana™ programs maintained on the Solana™ blockchain). The game control services can modify game state data (e.g., dynamic game state data 144 illustrated in FIG. 1), based on the game engine request. For example, assume the game engine request indicates that a user has moved from one area in the game to another area in the game (e.g., as discussed further below with regard to FIG. 5). The game control services can modify game state data recording the user's position in the game to reflect the movement from one location to another location. This is merely an example.

At block 410, the blockchain interface service refreshes the game engine from the chain. In an embodiment, all (or nearly all) game state data is maintained at the blockchain. As discussed above, at block 408 the game control services update the game state data on the blockchain. As discussed above in relation to FIG. 3, this game state data is used to generate the graphical presentation for the user. At block 410, the blockchain interface service retrieves the updated game state data and uses it to update the graphical presentation of the game, for the user (e.g., as discussed above in relation to FIG. 3).

Alternatively, or in addition, the game engine can maintain some game state data locally for the user (e.g., game state data relevant only to the local user, or a temporary cache duplicating a portion of the blockchain game state data) and can update that local game state data directly, without using the blockchain. In this example, the blockchain maintains a canonical record of the game state data, but the game engine maintains additional game state data locally. This can allow for more rapid refresh of the game presentation using temporary game state data, without requiring communication to and from the blockchain before updating the game presentation, while maintaining the permanent game state data securely on the distributed blockchain.

### Tracking Game Movement Using the Blockchain

FIG. 5 is a flowchart 500 illustrating tracking movement for an extensible blockchain application platform, according to one embodiment. At block 502 a movement control service receives a movement request. In an embodiment, the movement control service is a software program deployed on a blockchain (e.g., one of the game control services 148 illustrated in FIG. 1). For example, the movement control service can be a program deployed on the Solana™ blockchain. This is merely one example. Alternatively, the movement control service can be the movement control service 216 illustrated in FIG. 2, and can be deployed outside of the blockchain (e.g., deployed as part of the game engine 130 illustrated in FIG. 1). In this embodiment, the movement control service is deployed outside of the blockchain and interacts with programs deployed on the blockchain (e.g., the game control services 148 deployed in the blockchain layer 140 illustrated in FIG. 1) to control gameplay.

In an embodiment, the movement control service receives the movement request from a game engine (e.g., the game engine 130), or from a component of the game engine. For example, a user can interact with the game and request movement of an object (e.g., a ship) and cargo (e.g., cargo items held by the user) within the gameplay environment. In an embodiment, the object and cargo are both represented as tokens in a blockchain (e.g., NFTs maintained in the blockchain layer 140 illustrated in FIG. 1). The movement request can identify the tokens for movement (e.g., the object and cargo), the origin (e.g., the current location of the object and cargo), and the desired destination.

At block 504, the movement control service identifies object characteristics for the object being moved. In an embodiment, the object includes both static characteristics and dynamic characteristics. The static characteristics can be longer term characteristics (e.g., dimensions, weight, speed, maximum fuel, permitted cargo, presentation characteristics, and any other suitable characteristics). The static characteristics can be maintained in the blockchain (e.g., as part of the static game state data 146 illustrated in FIG. 1). The dynamic characteristics can be more frequently changing characteristics (e.g., location, current cargo, current fuel level, and any other suitable characteristics). The dynamic characteristics can also be maintained in the blockchain (e.g., as part of the dynamic game state data 144 illustrated in FIG. 1).

At block 506, the movement control service identifies cargo characteristics. In an embodiment, the object being moved does not include cargo. In this embodiment, the flow proceeds to block 508. Assuming the object includes cargo, the movement control service identifies both static and dynamic characteristics of the cargo. The static characteristics can again be longer term characteristics (e.g., dimensions, weight, value, presentation characteristics, and any other suitable characteristics), and can again be maintained in the blockchain (e.g., as part of the static game state data 146 illustrated in FIG. 1). The dynamic characteristics can again be more frequently changing characteristics (e.g., location, expiration status, or any other suitable characteristics) and can again also be maintained in the blockchain (e.g., as part of the dynamic game state data 144 illustrated in FIG. 1).

In an embodiment, the object being moved, the cargo, or both, can be represented using tokens stored on the blockchain (e.g., NFTs or semi-fungible tokens). Further, in an embodiment these items can be imported into the game environment (e.g., from the real world) or exported out into the game environment. For example, users may be permitted to maintain NFTs representing the objects in locations outside of the game environment, and may be permitted to buy, sell, or transfer the tokens to other users (e.g., outside of the game environment). In an embodiment, the movement control service identifies whether either, or both, of the object and cargo are being imported into the game environment. For example, the movement control service determines whether the token associated with the object, cargo, or both, is recorded as being previously imported into the game environment.

In addition, the movement control service, or another suitable service (e.g., an import or export control service) can control import of items into the gameplay environment and export of items out of the gameplay environment, separate from a movement request. For example, a service can receive an import request for an item at a specified location (e.g., the user's current location in the gameplay environment). As discussed below in relation to FIGS. 7 and 8, the service can determine whether importation of the item is permitted at the specified location. In an embodiment, importation of items into the gameplay environment is managed using a suitable deposit function for the corresponding blockchain, while exportation of items from the game environment is managed using a suitable withdraw function for the corresponding blockchain.

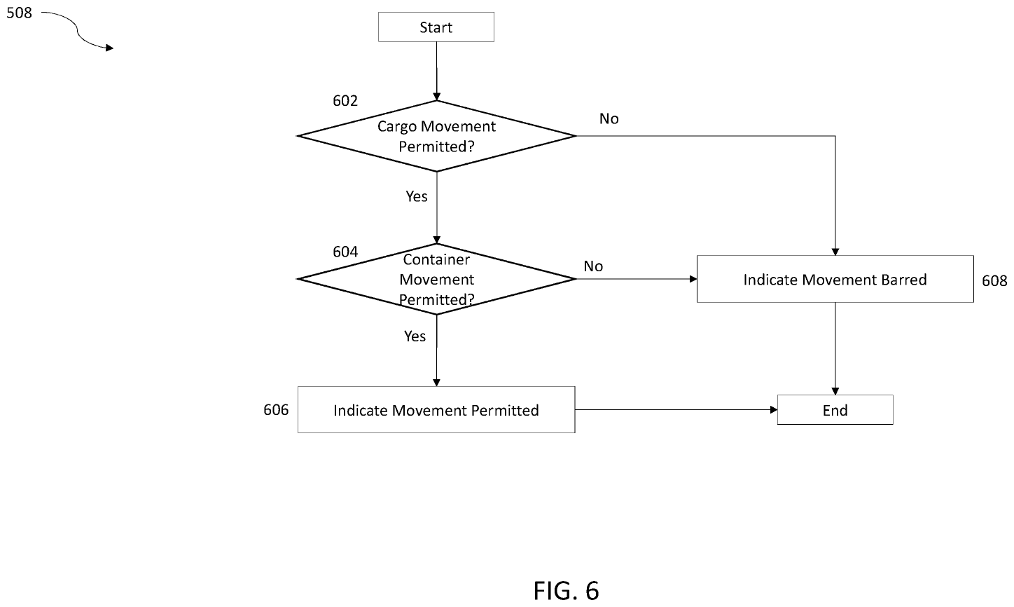

At block 508, the movement control service determines whether the requested movement is permitted. In an embodiment, the movement control service determines both whether the object being moved is permitted to move in the requested way, and whether the cargo (e.g., if cargo is present) is permitted to move. For example, an object or cargo may only be permitted to be imported into the game environment from particular origin locations. As another example, an object may not be permitted to move as requested because of a collision with another object in the game environment (e.g., a stationary object or a moving object), a characteristic of the object (e.g., a lack of fuel or a type of the object) or for some reason. These are discussed further, below, with regard to FIGS. 6-9. Assuming movement is permitted, the flow proceeds to block 510.

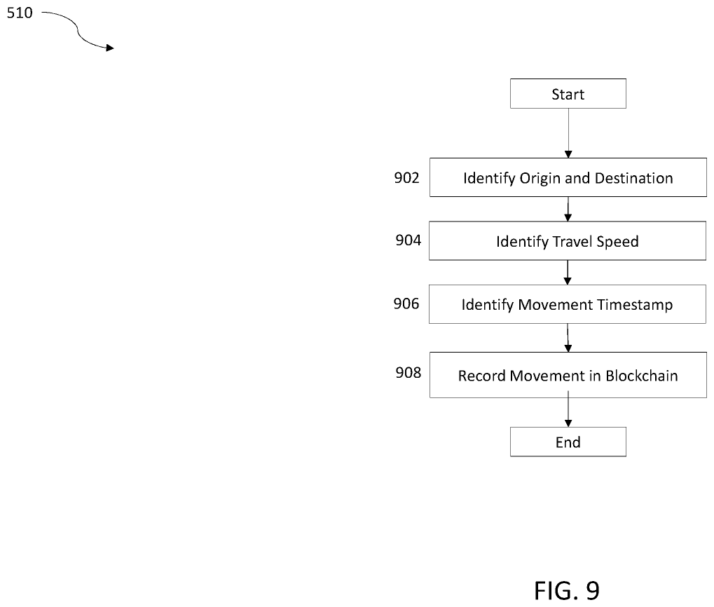

At block 510, the movement control service completes the movement. For example, the movement control service can identify the origin, destination, travel speed, and movement timestamp for the movement. The movement control service can use that data to identify any collisions in the environment and, if there are no collisions, to complete the movement and record the updated game state in the blockchain. This is discussed further, below, with regard to FIG. 9.

Returning to block 508, if movement is not permitted, the flow proceeds to block 512. At block 512, the movement control service denies the movement request. In an embodiment, the movement control service indicates the failure to the game engine, and the game engine notifies the user of the movement failure. For example, the game engine can provide the user with a suitable error message or notification identify the failure and providing a reason for the failure.

FIG. 6 is a flowchart illustrating determining whether movement is permitted, according to one embodiment. In an embodiment, FIG. 6 corresponds with block 508 illustrated in FIG. 5, above. At block 602 a movement control service determines whether cargo movement is permitted. In an embodiment, as discussed above in relation to FIG. 5, the movement control service is a software program deployed on a blockchain (e.g., one of the game control services 148 illustrated in FIG. 1). Alternatively, the movement control service can be deployed outside of the blockchain (e.g., deployed as part of the game engine 130 illustrated in FIG. 1) and can interact with other programs deployed on the blockchain (e.g., the game control services 148 deployed in the blockchain layer 140 illustrated in FIG. 1) to control gameplay.

In an embodiment, the movement control service determines whether the movement request includes cargo. If not, the flow proceeds to block 604. If the movement request includes cargo, the movement control service determines whether movement of the cargo is permitted. For example, if the cargo is being imported into the game environment (e.g., it is not currently present in the game environment), movement may not be permitted (e.g., depending on the origin location of the movement). This is discussed further, below, with regard to FIG. 7. If cargo movement is permitted, the flow proceeds to block 604.

At block 604, the movement control service determines whether the container (e.g., a spaceship) is permitted to move as requested. For example, if the container is being imported into the game environment (e.g., it is not currently present in the game environment), movement may not be permitted (e.g., depending on the origin location of the movement). As another example, the container may not have sufficient fuel to move as requested, the movement may cause the container to collide with another object in the game environment (e.g., a stationary object or a moving object), or the container may not be permitted to move for another suitable reason. This is discussed further, below, with regard to FIGS. 8-9. If movement is permitted, the flow proceeds to block 606.

At block 606, the movement control service indicates that the requested movement is permitted. In an embodiment, as discussed above in relation to FIG. 5, the movement control service then updates the game state to reflect the movement. Returning to blocks 602 and 604, if either cargo or container movement is not permitted, the flow proceeds to block 608.

At block 608, the movement control service indicates that the requested movement is barred. In an embodiment, as discussed above in relation to FIG. 5, the movement control service then denies the movement request.

FIG. 7 is a flowchart illustrating determining whether cargo movement is permitted, according to one embodiment. In an embodiment, FIG. 7 corresponds with block 602, illustrated in FIG. 6, above. At block 702 a movement control service determines whether the origin is located in an official dimension. In an embodiment, as discussed above in relation to FIG. 5, the movement control service is a software program deployed on a blockchain (e.g., one of the game control services 148 illustrated in FIG. 1). Alternatively, the movement control service can be deployed outside of the blockchain (e.g., deployed as part of the game engine 130 illustrated in FIG. 1) and can interact with other programs deployed on the blockchain (e.g., the game control services 148 deployed in the blockchain layer 140 illustrated in FIG. 1) to control gameplay.

In an embodiment, the gameplay environment can include official dimensions and un-official dimensions. Some (or all) gameplay rules can be enforced only when a user is located in an official dimension in the gameplay environment. For example, as discussed above and further below, a user may be permitted to import cargo items into the gameplay environment from only certain locations within the gameplay environment. In an embodiment, this is enforced only in official dimensions. Un-official dimensions can have different, or no, rules governing movement of cargo. If the movement control service determines that the origin is located in an official dimension, the flow proceeds to block 704. If the movement control service determines that the origin is located in an un-official dimension, the flow proceeds to block 708, discussed further below.

At block 704, the movement control service determines whether the cargo is importing new items. As discussed above, in an embodiment cargo items may be represented using tokens in a blockchain (e.g., NFTs or semi-fungible tokens). The movement control service can determine whether the token, or tokens, associated with the cargo already exist in the gameplay environment or are being imported. If the movement control service determines that the cargo is importing new items, the flow proceeds to block 706. If the movement control service determines that the cargo is not importing new items, the flow proceeds to block 708, discussed further below.

At block 706, the movement control service determines whether the origin location bars importing new items. In an embodiment, cargo items may only be imported into the gameplay environment at certain locations in the gameplay environment. For example, one or more portal locations can be defined in the gameplay environment, and the user is only permitted to import new cargo items at the portal locations (or at a subset of the portal locations). The movement control service can determine whether the origin of the movement corresponds to a location permitted for item import (e.g., a suitable portal location). If the movement control service determines that the origin location bars importing items, the flow proceeds to block 710.

As discussed above in relation to block 508 illustrated in FIG. 5, similar techniques can be applied to importing (or exporting) items into the gameplay environment separately from moving the items. The movement service (or another suitable service) can identify an item for import or export and a location in the gameplay environment. The service can determine whether import or export are permitted at the specified location, and can provide a success or failure response accordingly.

At block 710, the movement control service indicates that cargo movement is barred. If the flow instead proceeds to block 708 (i.e., from any of blocks 702, 704, or 706), the movement control service indicates that cargo movement is permitted.

FIG. 8 is a flowchart illustrating determining whether container movement is permitted, according to one embodiment. In an embodiment, FIG. 8 corresponds with block 604, illustrated in FIG. 6, above. At block 802 a movement control service determines whether the object is located in an official dimension. In an embodiment, as discussed above in relation to FIG. 5, the movement control service is a software program deployed on a blockchain (e.g., one of the game control services 148 illustrated in FIG. 1). Alternatively, the movement control service can be deployed outside of the blockchain (e.g., deployed as part of the game engine 130 illustrated in FIG. 1) and can interact with other programs deployed on the blockchain (e.g., the game control services 148 deployed in the blockchain layer 140 illustrated in FIG. 1) to control gameplay.

As discussed above in relation to FIG. 7, in an embodiment, the gameplay environment can include official dimensions and un-official dimensions. Some (or all) gameplay rules can be enforced only when a user is located in an official dimension in the gameplay environment. If the movement control service determines that the origin is located in an official dimension, the flow proceeds to block 804. If the movement control service determines that the origin is located in an un-official dimension, the flow proceeds to block 810, discussed further below.

At block 804, the movement control service determines whether the object is being imported into the gameplay environment. As discussed above, in an embodiment containers (e.g., spaceships) may be represented using tokens in a blockchain (e.g., NFTs or semi-fungible tokens). The movement control service can determine whether the token, or tokens, associated with the container already exist in the gameplay environment or are being imported. If the movement control service determines that the container is being imported, the flow proceeds to block 806. If the movement control service determines that the container is not being imported, the flow proceeds to block 810, discussed further below.

At block 806, the movement control service determines whether the origin location bars importing the container. As discussed above in relation to FIG. 7, in an embodiment new items (e.g., new container spaceships) may only be imported into the gameplay environment at certain locations in the gameplay environment. For example, one or more portal locations can be defined in the gameplay environment, and the user is only permitted to import new container items at the portal locations (or at a subset of the portal locations). The movement control service can determine whether the origin of the movement corresponds to a location permitted for item import (e.g., a suitable portal location). If the movement control service determines that the origin location does not bar importing the container, the flow proceeds to block 808. If the movement control service determines that the origin location bars importing the container, the flow proceeds to block 812.

At block 808, the movement control service determines whether movement to the requested destination is permitted. For example, the container may not have sufficient fuel to reach the requested destination, may collide with another object at the destination (e.g., a stationary object at the destination), or may not be permitted to the destination for another suitable reason. In an embodiment, the movement control service identifies potential collisions with stationary objects at block 808, and identifies potential collisions with moving objects as part of completing movement of the container, as discussed further below with regard to FIG. 9. This is merely an example.

In an embodiment, if the movement control service determines that movement to the requested destination is permitted, the flow proceeds to block 810. If the movement control service determines that movement to the requested destination is not permitted, the flow proceeds to block 812.

At block 812, the movement control service indicates that container movement is barred. If the flow instead proceeds to block 810 (i.e., from any of blocks 802, 804, or 808), the movement control service indicates that container movement is permitted.

FIG. 9 is a flowchart further illustrating completing object movement, according to one embodiment. In an embodiment, FIG. 9 corresponds with block 510 illustrated in FIG. 5, above. At block 902 a movement control service identifies the origin and destination. In an embodiment, as discussed above in relation to FIG. 5, the movement control service is a software program deployed on a blockchain (e.g., one of the game control services 148 illustrated in FIG. 1). Alternatively, the movement control service can be deployed outside of the blockchain (e.g., deployed as part of the game engine 130 illustrated in FIG. 1) and can interact with other programs deployed on the blockchain (e.g., the game control services 148 deployed in the blockchain layer 140 illustrated in FIG. 1) to control gameplay.

In an embodiment, the movement control service identifies the origin of the movement from gameplay state data (e.g., stored in a blockchain). For example, the current location of the container (e.g., spaceship) being moved can be used as the origin. Alternatively, or in addition, the movement control service identifies the origin from a movement request (e.g., the movement request received at block 502 illustrated in FIG. 5). In an embodiment, the movement control service identifies the destination from the movement request. These are merely examples, and the movement control service can use any suitable technique to identify the origin and destination.

At block 904, the movement control service identifies travel speed for the container (e.g., for the spaceship). In an embodiment, the travel speed is a characteristic associated with the container (e.g., a static characteristic) and maintained on the blockchain (e.g., as part of the static game state data 146 illustrated in FIG. 1). This is merely an example, and the travel speed can be a dynamic characteristic, can be associated with additional items (e.g., the user or items in the gameplay environment), and can be determined using any suitable technique.

At block 906, the movement control service identifies the movement timestamp. In an embodiment, the movement timestamp indicates a time at which movement begins. Further, in an embodiment, a current location for all objects in the gameplay environment can be derived from four characteristics: the origin, the destination, the travel speed, and the movement timestamp. In this embodiment, a complete map of all objects in the gameplay environment can be derived from these four characteristics, and can be used to control movement and reflect the locations of the objects (e.g., as part of a graphical presentation).

At block 908, the movement control service records the movement in the blockchain. For example, the movement control service can update dynamic game state data (e.g., the dynamic game state data 144 illustrated in FIG. 1) to reflect the change in positon of the object and cargo (if cargo is present). The updated data is then recorded on the blockchain, and used to control further aspects of gameplay (e.g., as discussed above in relation to FIGS. 3-4).

Further, in an embodiment, the movement control service can use the origin, destination, travel speed, and movement timestamp to identify any collisions with other moving objects in the environment. If the movement control service identifies a collision with a moving object, it can fail to record the movement in the blockchain and instead indicate an error.

### Additional Considerations

In the current disclosure, reference is made to various embodiments. However, it should be understood that the present disclosure is not limited to specific described embodiments. Instead, any combination of the following features and elements, whether related to different embodiments or not, is contemplated to implement and practice the teachings provided herein. Additionally, when elements of the embodiments are described in the form of “at least one of A and B,” it will be understood that embodiments including element A exclusively, including element B exclusively, and including element A and B are each contemplated. Furthermore, although some embodiments may achieve advantages over other possible solutions or over the prior art, whether or not a particular advantage is achieved by a given embodiment is not limiting of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, embodiments described herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments described herein may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations or block diagrams of methods, apparatuses (systems), and computer program products according to embodiments of the present disclosure. It will be understood that each block of the flowchart illustrations or block diagrams, and combinations of blocks in the flowchart illustrations or block diagrams, can be implemented by computer program instructions. These computer program instructions may be provided to a processor of a computer, a special purpose computer, or other programmable data processing apparatus to produce a machine, such that the instructions, which execute via the processor of the computer or other programmable data processing apparatus, create means for implementing the functions/acts specified in the block(s) of the flowchart illustrations or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations or block diagrams.

The flowchart illustrations and block diagrams in the Figures illustrate the architecture, functionality, and operation of possible implementations of systems, methods, and computer program products according to various embodiments of the present disclosure. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order or out of order, depending upon the functionality involved. It will also be noted that each block of the block diagrams or flowchart illustrations, and combinations of blocks in the block diagrams or flowchart illustrations, can be implemented by special purpose hardware-based systems that perform the specified functions or acts, or combinations of special purpose hardware and computer instructions.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method, comprising:
generating a game engine request for an electronic game based on user interaction with a graphical game engine for the electronic game;
updating game state for the electronic game on a blockchain by transmitting the game engine request to at least one of a plurality of software programs maintained in the blockchain; and
modifying graphical presentation of the electronic game based on the updated game state on the blockchain.

2. The method of claim 1, further comprising:
determining that the game engine request modifies game state for the electronic game, prior to transmitting the game engine request to the at least one of the plurality of software programs maintained in the blockchain.

3. The method of claim 1, wherein modifying graphical presentation of the electronic game based on the updated game state on the blockchain comprises:
retrieving the updated game state by accessing at least one of the plurality of software programs maintained in the blockchain; and
modifying the graphical presentation of the electronic game based on the retrieved updated game state.

4. The method of claim 1, wherein the game engine request comprises a request for movement of an item in the electronic game, the method further comprising:
identifying, using the plurality of software programs maintained in the blockchain, one or more characteristics of the item;
determining, based on the one or more characteristics of the item and using the plurality of software programs maintained in the blockchain, that movement of the item is permitted; and
updating game state for the electronic game to complete movement of the item, using the plurality of software programs maintained in the blockchain.

5. The method of claim 4, wherein the item comprises a token maintained in the blockchain.

6. The method of claim 5,
wherein the request for movement comprises a request to import the item into the electronic game, and
wherein the determining, based on the one or more characteristics of the item and using the plurality of software programs maintained in the blockchain, that movement of the item is permitted further comprises:
determining, using the plurality of software programs maintained in the blockchain, that import of the item into the electronic game is permitted.

7. The method of claim 6, wherein the item comprises an object and cargo associated with the electronic game, and wherein the token maintained in the blockchain relates to the cargo.

8. The method of claim 1, further comprising:
generating a second game engine request for the electronic game based on a second user interaction with the graphical game engine for the electronic game;
determining that the second game engine request does not modify game state for the electronic game; and
declining to update game state for the electronic game on the blockchain, based on the determining that the second game engine request does not modify game state for the electronic game.

9. The method of claim 1, further comprising:
generating a second game engine request for the electronic game based on a second user interaction with the graphical game engine for the electronic game, wherein the second game engine request comprises a second request for movement of a second item in the electronic game;
determining, using the plurality of software programs maintained in the blockchain, that movement of the second item is not permitted; and
declining to update game state for the electronic game to complete movement of the second item, based on the determining that movement of the second item is not permitted.

10. The method of claim 9,
wherein the second item comprises a second token maintained in the blockchain,
wherein the second request for movement comprises a request to import the second item into the electronic game; and
wherein the determining, using the plurality of software programs maintained in the blockchain, that movement of the second item is not permitted comprises determining that import of the second item is not permitted.

11. A system, comprising:
a processor; and
a memory having instructions stored thereon which, when executed on the processor, performs operations comprising:
generating a game engine request for an electronic game based on user interaction with a graphical game engine for the electronic game;
updating game state for the electronic game on a blockchain by transmitting the game engine request to at least one of a plurality of software programs maintained in the blockchain; and
modifying graphical presentation of the electronic game based on the updated game state on the blockchain.

12. The system of claim 11, the operations further comprising:
determining that the game engine request modifies game state for the electronic game, prior to transmitting the game engine request to the at least one of the plurality of software programs maintained in the blockchain.

13. The system of claim 11, wherein modifying graphical presentation of the electronic game based on the updated game state on the blockchain comprises:
retrieving the updated game state by accessing at least one of the plurality of software programs maintained in the blockchain; and
modifying the graphical presentation of the electronic game based on the retrieved updated game state.

14. The system of claim 11, wherein the game engine request comprises a request for movement of an item in the electronic game, the operations further comprising:
identifying, using the plurality of software programs maintained in the blockchain, one or more characteristics of the item;
determining, based on the one or more characteristics of the item and using the plurality of software programs maintained in the blockchain, that movement of the item is permitted; and
updating game state for the electronic game to complete movement of the item, using the plurality of software programs maintained in the blockchain.

15. The system of claim 14,
wherein the item comprises a token maintained in the blockchain,
wherein the request for movement comprises a request to import the item into the electronic game, and
wherein the determining, based on the one or more characteristics of the item and using the plurality of software programs maintained in the blockchain, that movement of the item is permitted further comprises:
determining, using the plurality of software programs maintained in the blockchain, that import of the item into the electronic game is permitted.

16. A non-transitory computer-readable medium having instructions stored thereon which, when executed by a processor, performs operations comprising:
generating a game engine request for an electronic game based on user interaction with a graphical game engine for the electronic game;
updating game state for the electronic game on a blockchain by transmitting the game engine request to at least one of a plurality of software programs maintained in the blockchain; and
modifying graphical presentation of the electronic game based on the updated game state on the blockchain.

17. The non-transitory computer-readable medium of claim 16, the operations further comprising:
determining that the game engine request modifies game state for the electronic game, prior to transmitting the game engine request to the at least one of the plurality of software programs maintained in the blockchain.

18. The non-transitory computer-readable medium of claim 16, wherein modifying graphical presentation of the electronic game based on the updated game state on the blockchain comprises:
retrieving the updated game state by accessing at least one of the plurality of software programs maintained in the blockchain; and
modifying the graphical presentation of the electronic game based on the retrieved updated game state.

19. The non-transitory computer-readable medium of claim 16, wherein the game engine request comprises a request for movement of an item in the electronic game, the operations further comprising:
identifying, using the plurality of software programs maintained in the blockchain, one or more characteristics of the item;
determining, based on the one or more characteristics of the item and using the plurality of software programs maintained in the blockchain, that movement of the item is permitted; and
updating game state for the electronic game to complete movement of the item, using the plurality of software programs maintained in the blockchain.

20. The non-transitory computer-readable medium of claim 19,
wherein the item comprises a token maintained in the blockchain,
wherein the request for movement comprises a request to import the item into the electronic game, and
wherein the determining, based on the one or more characteristics of the item and using the plurality of software programs maintained in the blockchain, that movement of the item is permitted further comprises:
determining, using the plurality of software programs maintained in the blockchain, that import of the item into the electronic game is permitted.
